(19) United States
(12) Patent Application Publication
(10) Pub. No.: US 2007/0005848 A1
(43) Pub. Date: Jan. 4, 2007

(54) Satellite radio-computer interface

(76) Inventor: G. Scott MacLean, Strongsville, OH (US)

Correspondence Address: Elliott D. Frutkin, 830 Still Creek Lane, Gaithersburg, MD, 20878, US

(21) Appl. No.: 11/490,451

(22) Filed: Jul. 21, 2006

Related U.S. Application Data
(63) Continuation-in-part of application No. 10/961,854, filed on Oct. 8, 2004.

(51) Int. Cl. G06F 13/38

(52) U.S. Cl. 710/62

(57) ABSTRACT

One exemplary process records audio data by establishing communications between a recording device and a transceiver and commanding the transceiver to tune to a specified or current channel, as determined from the last time communications between the recording device and the transceiver was established. A user interface screen is displayed and if available a cache of available radio channel numbers is loaded and names presented on the user interface screen. During a start up interval the exemplary embodiment periodically queries the transceiver for a name, number, genre and currently playing artist and song for every channel available radio channel. Subsequent to the start up interval the system records the current program to a memory store in a specified file format. The system queries the transceiver for channel, artist and song information by alternating between a currently playing channel, and other available channels to update a listing of channels while monitoring changes to the currently playing channel at more frequent intervals.

### CROSS REFERENCE TO RELATED APPLICATIONS

The present application is a continuation in part of application Ser. No. 10/961,854 filed Oct. 8, 2004 and claims priority from provisional application Ser. No. 60/700,364, filed Jul. 18, 2005 entitled “PC based audio recorder”.

### FIELD OF THE INVENTION

The present invention concerns an interface for providing radio signals to a computer for storage and replay at a later time.

### BACKGROUND ART

There are currently at least two providers of subscription satellite radio services. These providers sell a car-mounted radio receiver that decodes radio signals and provides an analog output signal to a car mounted amplifier and speakers. The motorist having such a receiver can tune to a large and growing number of different satellite radio stations. These receivers decode digital signals that are currently broadcast from transmitters carried by orbiting satellites to a wide broadcast area.

One existing receiver receives its operating power from the car battery by means of a male plug that mates with a female connector on the receiver. Additionally, the existing receiver has a serial communications capability for communicating song titles and time of play information for the motorist on a dash mounted control that includes a visual display and also includes actuators for selecting different radio stations on an available list of such stations. Two way serial communications between the receiver and the control allow the motorist to issue commands to change the station for example, and also allow play duration and song titles to be presented on the control's visual display.

The serial communications supported by an existing receiver supports serial data transmission in so-called RS-232 format. Details of the mechanical, electrical and functional specifications for this protocol are available in the text entitled “Computer Networks” by Andrew Tannenbaum, Prentice Hall, 1989. The RS-232 protocol supports two way (duplex) communications with a handshake agreement based on a sequence of transmissions. Once the source and recipient agree on the originator of large blocks of data, this data can be sent from the source to the recipient at a steady stream at a rate depending on the hardware that implements the interface. In the present instance, the source is either the receiver which sends data concerning the song being played or the control for setting the radio station of the receiver.

Published United States patent applications 2004/0143349 and 2003/0028796 to Roberts et al concern audio recording systems that simplify the process of recording and subsequently access the recording or audio.

### SUMMARY OF THE INVENTION

Software on the computer manages the storing and organization of the music that is received from the receiver. This software also maintains the two-way communications between the computer and the receiver for display of information and setting of the radio station that is received.

One exemplary process records audio data by establishing communications between a recording device and a transceiver and commanding the transceiver to tune to a specified or current channel, as determined from the last time communications between the recording device and the transceiver was established. A user interface screen is displayed and if available a cache of available radio channel numbers is loaded and names presented on the user interface screen.

During a start up interval the exemplary embodiment queries the transceiver for a name, number, genre and currently playing artist and song for every channel available radio channel. Subsequent to the start up interval the system records the current program to a memory store in a specified file format. The system queries the transceiver for channel, artist and song information by alternating between a currently playing channel, and other available channels to update a listing of channels while monitoring changes to the currently playing channel at more frequent intervals.

These and other objects advantages and features of the invention will be better understood when reviewed in conjunction with the accompanying drawings.

### BRIEF DESCRIPTION OF THE DRAWINGS

FIG. 1 is a perspective view of an assembly that includes two connectors and a module which contains electronics for converting from one format signal to a second format signal;

FIGS. 2A, 2B and 2C are detailed schematics of circuitry for practicing the invention;

FIG. 3A and 3B are perspective views of an alternate housing for the components of the FIG. 1 assembly;

FIG. 4 is a schematic depiction of a computer and receiver coupled to the system using the alternate housing construction;

FIGS. 5, 6, and 7 are screen shots of displays presented to a user of the exemplary embodiment of the invention; and

FIG. 8 is an overview flowchart of the software.

### EXEMPLARY EMBODIMENT FOR PRACTICING THE INVENTION

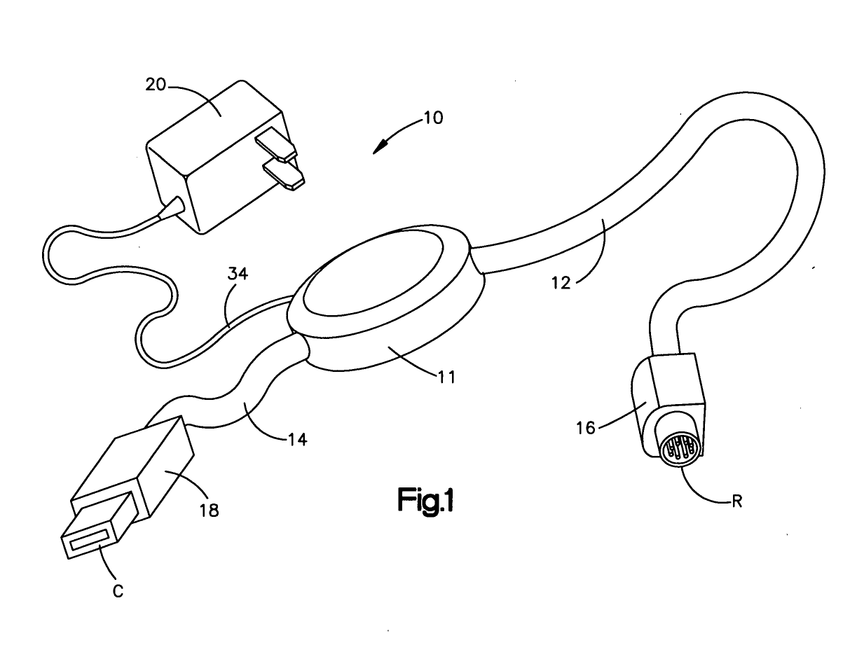

FIG. 1 depicts an assembly 10 that interposed between a radio receiver R and a serial interface such as a USB port of a computer C. The assembly transmits serial communications signals from the receiver R to the computer C. In one exemplary embodiment the assembly converts a first format serial signal to a second format serial signal that is coupled to the computer C. In this exemplary embodiment the assembly 10 also powers the radio receiver R.

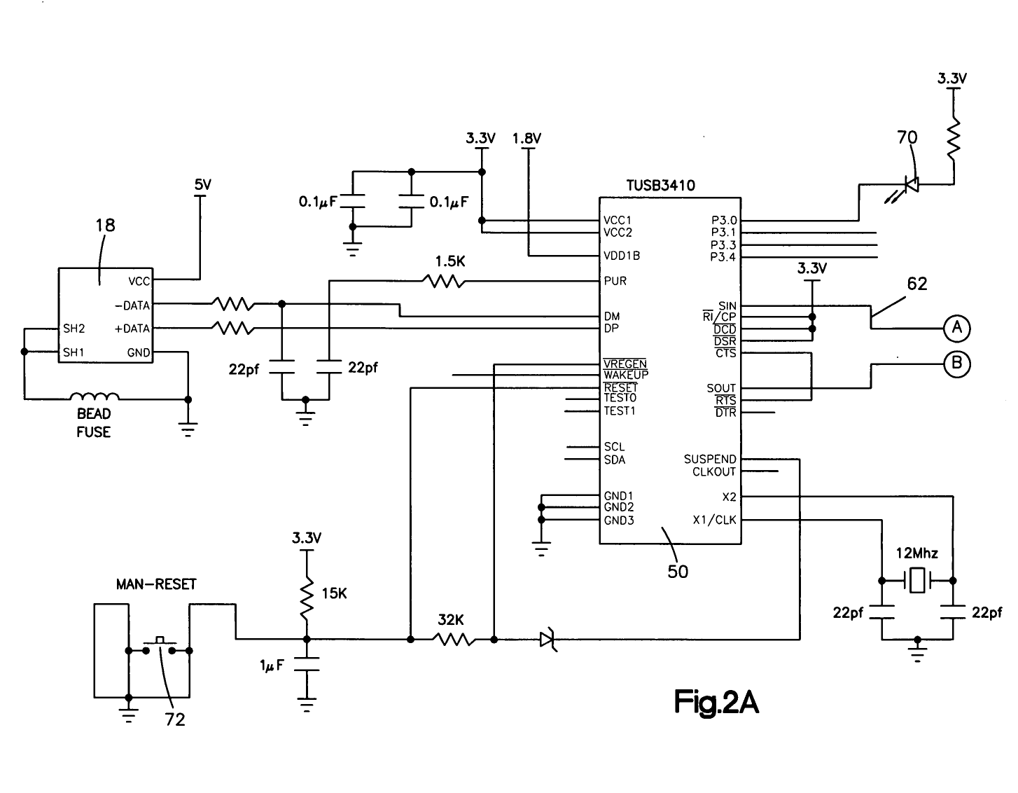

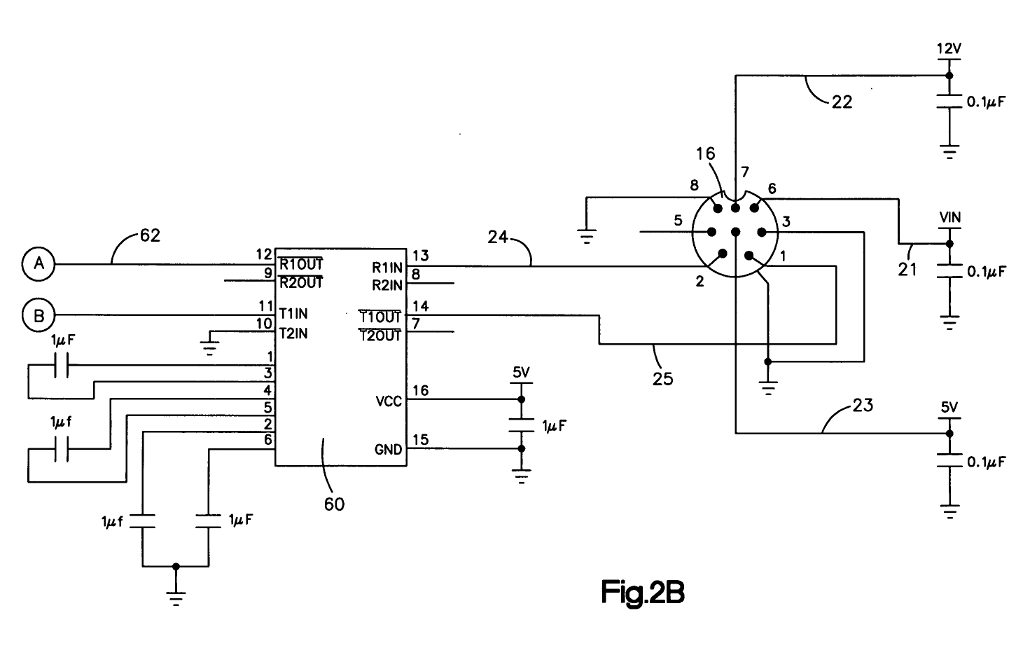

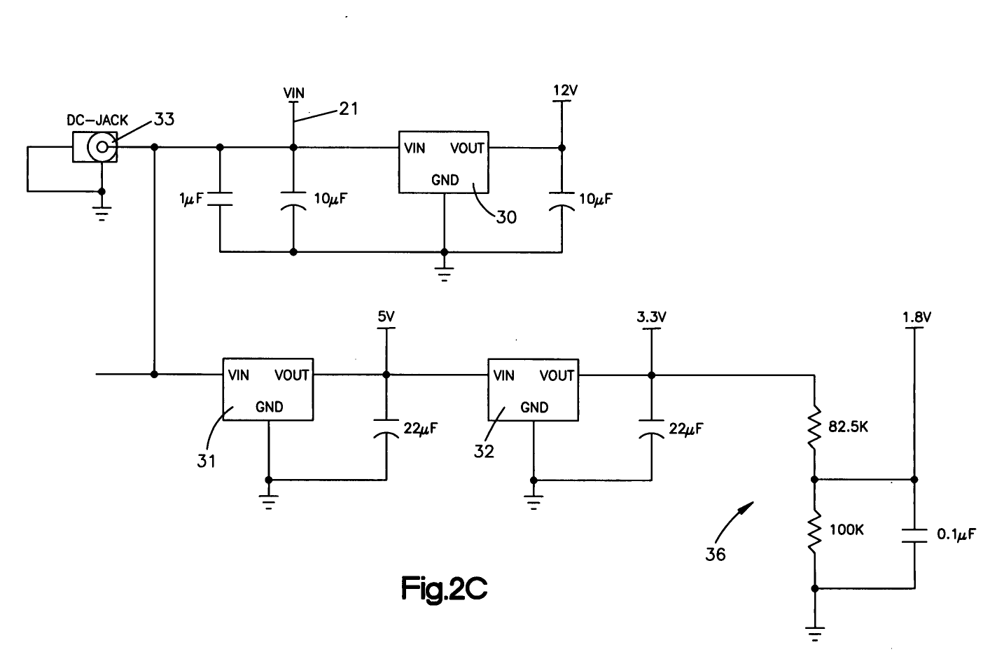

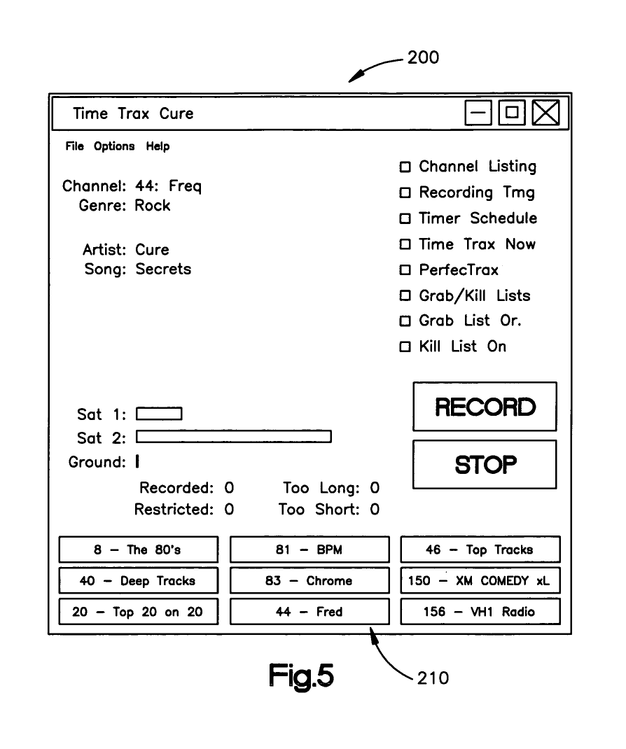

As noted, an existing, prior art satellite radio receiver R receives satellite radio signals and includes an analog output coupled by a cable 13 (FIG. 4) between the receiver R and the computer C which transmits audio input to the line-level input (not shown) of the computer C. FIG. 1 includes an electronics module 11 coupled by conductor carrying cables 12, 14 to two connectors 16, 18. A first connector 16 is preferably an eight pin mini-din connector that mates with an existing radio receiver unit R. The configuration of the eight pins of this connector is depicted in FIG. 2C. In addition to the ground connection, the pins of the receiver's mini-din female pins receives an unregulated signal of 12 volts DC at an input 21, a regulated power signal of 12 volts at an input 22, and a regulated enable signal of five volts at an input 23. The receiver R communicates information concerning listening content by outgoing RS-232 signals at an output 24. The receiver R responds to incoming RS-232 signals regarding listener choice of station at an output 25.

A power supply 20 (FIG. 1) having a standard transformer and rectifier creates an 12 volt DC output that is coupled by a cord 34 to the module 11 for powering circuit components contained within the module 11 as well as the receiver R. The module supports three voltage regulators 30, 31, 32 (FIG. 2C) that are coupled to the direct current signal at the input 21 (typically 12 volts DC) from the power supply 20. The module includes a standard DC input jack 33 for coupling an output from the power supply to these voltage regulators. The regulator 30 provides regulated 12 volt output and the regulator 31 provides the enable voltage signal of 5 volts DC that is coupled to the receiver R. The third voltage regulator 32 supplies power of 3.3 volts DC to other circuit components contained in the module 11. A voltage divider 36 provides a stepped down voltage of 1.8 volts.

The module 11 also includes a circuit 50 (FIG. 2A) for receiving RS-232 format signals from the receiver R and converting those signals to USB format signals. The exemplary system includes a model TUSB3410 USB to Serial port controller 50 commercially available from Texas Instruments. A Data Manual dated November 2003 published by Texas Instruments Incorporated describes the operation and functioning of this circuit and is incorporated herein by reference. The controller 50 contains necessary logic to communicate with the computer using the computer's USB bus. It contains a microcontroller unit and RAM and ROM for configuring the USB port of the computer when power is applied by the power supply 20.

The input connector 16 couples its RS-232 input 24 through a low level RS-232 handshake circuit 60 which co-ordinates RS-232 serial data transmission with a similar low level handshake circuit in the receiver R. The low-level to RS-232 conversion circuit is a MAX 232 integrated circuit from Dallas Semiconductor. The handshake circuit serves to pass the RS-232 signals from the receiver R to the controller in a controlled manner without overflow of data. To implement this function the circuit 60 changes signal levels from the receiver R to the circuit 50 as well as converting the signal levels of the signals sent by the circuit 50 to the receiver. One commercially available receiver R is made available to customers by XM Satellite Radio of Washington, D.C.

An output 62 from the circuit 60 is coupled to the controller 50 which converts the RS-232 formatted signals from the circuit 60 into signals satisfying the USB format. A summary of the USB format is available from the web site www.usb.org. The USB controller is a slave device to the computer C. It responds to control transaction requests from the computer such as requests for data from the receiver R. The controller sends and receives data to/from the computer C using a standard USB data format. Generally, the difference between a logic state of “1” and logic state of “0” for signals at the USB port is discerned by the computer based on the voltage difference between two Data inputs to the connector 18. The circuit 50 generates standard USB signals from the incoming RS-232 signals and transmits information containing song title, type and duration to the computer C.

Other signals originate at the computer C. One example of such a signal is generated by software on the computer to cause the receiver to change to a different radio station. These signals are transmitted by the computer through an appropriate USB connector to the circuit 50 which converts the USB formatted signals to RS-232 signals. The circuit 50 then transmits the commands to the T1ᵢₙ input of the circuit 60. This circuit 60 then negotiates a transfer to the receiver R of the command along the conductor 25 that is connected to the connector 16 which mates with a female connector of the receiver R. The communications protocol implemented by the software running on the computer C implements full duplex communications. The software executing on the computer C categorizes and stores the song (or other audio) in a manner controlled by the listener. The USB connector 18 conforms to the USB 2.0 standard and is well documented in the literature.

The circuit of FIGS. 2A, 2B and 2C includes debugging circuit components to facilitate modification of the default software that is included with the controller 50. To facilitate debugging the circuitry includes a light emitting diode 70 and a manual reset switch 72. When the controller is sending or receiving data a signal at an output 74 connected to the light-emitting diode 70 causes the diode to energize and thereby emit light.

In summary, the module 11 supplies power to the receiver R in the form of a regulated twelve volt DC signal and first enables RS-232 data transmission and then converts the received data from that format into a USB formatted signal for coupling to the computer C. Software executing on the computer C coordinates the analog audio output from the receiver with the song data transmitted by the module 11 to the computer and is described more completely below. An instruction manual entitled TimeTrax software, Listen to your favorite music on your time is incorporated herein by reference. One suitable source of software for this function is the assignee of the present invention, Time Trax Technologies, Inc., having a place of business at 12154 Darnestown Road, Suite 440, North Potomac, Md., 20878. This software organizes, filters, and stores the audio content from the receiver R.

### Alternate Embodiment

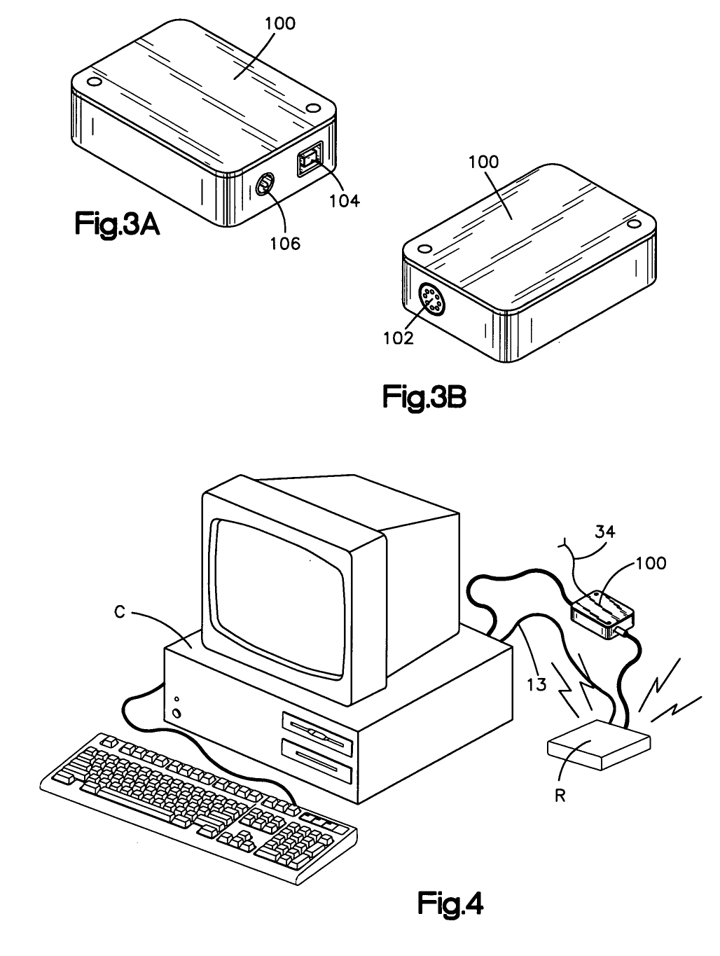

The FIG. 1 embodiment includes cables 12, 14 for routing signals into and out of the module 11. In an alternate embodiment shown in FIGS. 3A and 3B the module 11 is replaced by a housing 100 that rigidly supports connectors 102, 104 and includes a power input 106 for routing unregulated 12 volt signals into the housing. The housing 100 supports a custom circuit board to which the circuits 50, 60 and regulators 30, 31, 32, are attached. FIG. 4 is a depiction of this alternate embodiment coupled by cabling to a USB port on the back of a computer C. The output of the mini-din connector is coupled by means of cabling with a receiver R.

Software Overview

The function of the software executing on the computer C is as a Windows PC based audio recorder, combined with satellite tuner/receiver control software. The audio recorder has the ability to encode the recorded audio into various compressed audio formats in real-time, the primary one being MP3. Ancillary automated event scheduling functionality and filtering functionality is included.

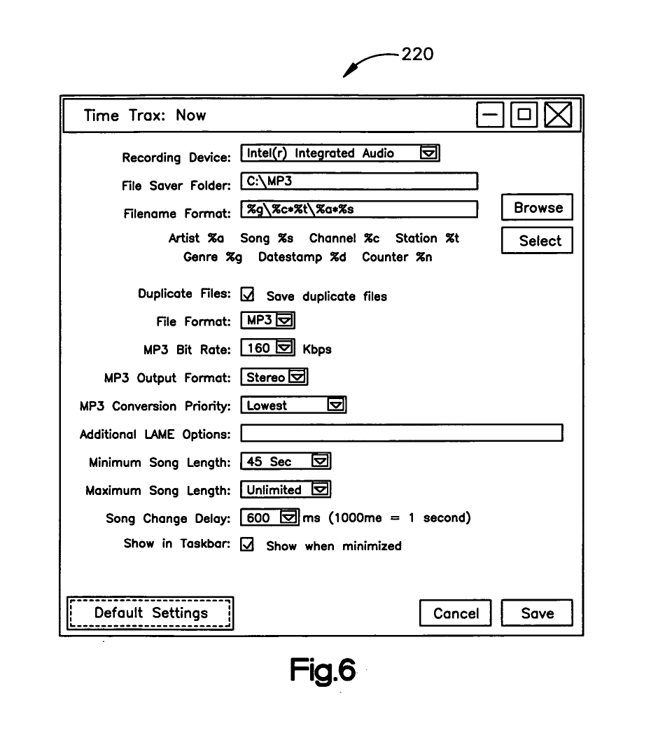

Operational Overview
1. When the software is started, it looks within the registry to identify a virtual serial port number that it successfully used previously to connect to the satellite tuner/receiver. If there is none, it begins searching through all available serial ports. It sends a query to each port, looking for an appropriate response from the tuner/receiver. It cycles through all available ports twice. If it does not see a response after trying each port twice, it fails and presents an error message. If there is a previously used port, it tries that port first, to expedite startup. If there is no response from that port, it then begins cycling through all ports.
2. Once communication is established with the tuner/receiver, it turns the tuner/receiver on and sends setup commands to it, identifying the tuner/receiver's serial number in the process. The software tunes to the current channel, as determined from the last time it was run.
3. Using the tuner/receiver's serial number, the software determines whether it is running as a registered copy. If not, it displays a registration screen.
4. The software displays the main screen 200 (FIG. 5). If a cache of available channels is stored from a previous run, it loads that cache and displays the channel numbers and names in a region 210.
5. Enumeration mode is entered. In this mode, the software queries the tuner/receiver for the name, number, genre and currently playing artist and song for every channel. It cycles through the entire list of channels twice, as radios do not accurately report channel information after tuner/receiver power-up for up to 30 seconds. During enumeration mode, no recording can be done.
6. When enumeration mode has completed, a normal running mode is begun. The software begins recording the current program to disk as a generic “capture”, in the file format defined by the main configuration screen of FIG. 5.
7. During normal running mode, the software queries the tuner/receiver for channel, artist and song information. It alternates between the currently playing channel, and all other channels in sequence, in very rapid succession, i.e. if channel 44 is playing, it will query for channel information for channels 1, 44, 2, 44, 3, 44, 4, 44 and so on. This way the entire listing of channels is updated, but the currently playing channel is watched for changes, and any song changes are identified very quickly.
8. When the program is changed by the user or by the song ending and another beginning, as defined by the artist/song information changing, it stops recording to the first capture file, and begins instantly recording to a second capture file. It alternates between the two capture files. If the software is in “record” mode, once it has started recording to the second capture file, it then renames the first capture file to the name of the song just recorded as defined in the configuration screen 200 depicted in FIG. 6. Otherwise, the software simply deletes the first capture file.

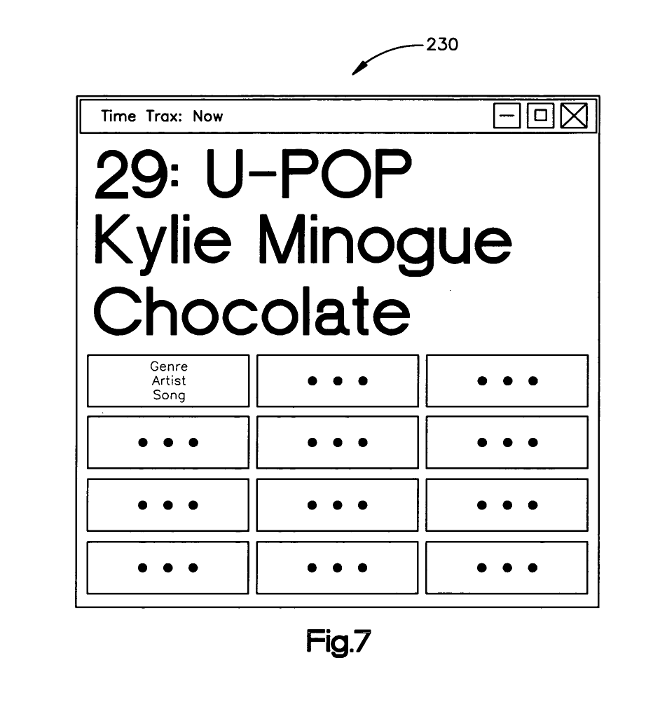

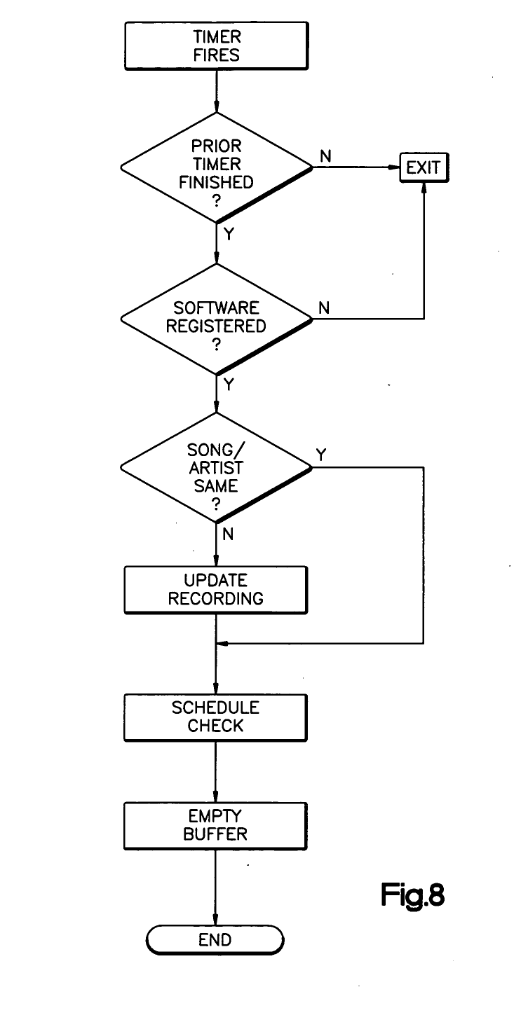

In-Depth Operational Overview
1. Every 200 ms, a software timer fires. This timer, named the “update” timer, contains most of the logic within the software.
2. Upon firing, the update timer first checks to make sure that a previous instance of the update timer is not still running. If so, it exits and allows the previous instance to complete.
3. Next, it checks to see if the software is running in unregistered mode. If so, it checks to see if 15 minutes has elapsed. If so, it shuts down, and displays a registration message.
4. Next, it checks to see if the current artist/song information matches the artist/song information from the last time the timer was run. If it does, it skips to the schedule check routine.
5. If the current artist/song information does not match the previous artist/song information, this indicates that a new song has begun. The current artist and song name are updated on the main screen, channel listing (switched to from a main screen), taskbar icon tooltip, and the TimeTrax Now (FIG. 7) screens.
6. The software applies the filename and directory path modification rules as defined in the configuration screen. If PerfecTrax is disabled, and the software has not recorded the song from the beginning to the end, the phrase “(incomplete)” is added to the filename.
7. The software delays for the amount of time specified in the configuration screen, then checks to make sure that the song should be recorded. It does so by applying these rules (note that if currently in a scheduled event, the rules for that event are analyzed instead of the default configuration rules):
8. Is the software currently in record mode, either manually or through a schedule? If not, do not record
9. If kill list is enabled, does song appear in filter list? If so, do not record
10. If grab list is enabled, does song appear in grab list? If not, do not record
11. If PerfecTrax is enabled, has the song been recorded since its beginning? If not, do not record
12. Is the song length less than the minimum song length? If so, do not record ***Mention the fact that this prevents recording DJ talking or commercials
13. Is the song length more than the maximum song length? If so, do not record *** Mention the fact that this prevents recording long programs
14. If “duplicate songs” is disabled, does a song by the same name already exist in the target directory? If so, do not record.
15. If the song is not to be recorded, the capture file is deleted, if the directory the capture file was in is empty then the directory is deleted, appropriate counters are updated, the log is updated, and the process skips to the schedule check routine.
16. The software analyzes the path and filename to ensure it does not contain any illegal characters, and makes changes as required. It then renames the capture file to the filename created by the configuration specification, updates the appropriate counters, updates the log, and moves to the schedule check routine.
17. Schedule Check Routine: This routine is executed after the artist/song analysis routine.
18. Each of the 10 schedule events is tested, from 1 to 10. If the current time falls within the start/end times (inclusive) of any of the scheduled events, that event is flagged as active. This procedure is deceptively complex, as start/end times must be checked across date changes, as well as for “every Tuesday” or “Monday through Friday” time events.
19. If an event is flagged as active and manual record mode is active, the manual record mode is stopped (Equivalent to the user clicking the “stop” button).
20. If an event is flagged as active and the event is already in progress, the data for the event (start time, end time, channel, etc) is checked against the current settings. If the data is different, the current settings are updated. This allows the modification of events that are currently in progress. If the channel has changed, the software executes a record Stop, changes the channel, then begins recording again.
21. If the event is not already executing, this indicates a new event is beginning. In this case, a record Stop is executed (if in record mode), the channel is changed to the scheduled channel, file configuration settings are set, and the recording begins.
22. If the software is in schedule recording mode, but no events were flagged as active, it indicates that a scheduled event has ended. A record Stop is executed, and all configuration parameters are returned to the configuration defaults from the event values.
23. Clock Update: Every 100 ms, the clock update routine is called. This routine updates the running elapsed (and remaining, for scheduled events) timers on screen, as well as updating the “Recording” labels, adding the “(Killed)” and “(Grabbed)” flags as required, and making various labels flash on screen as required.
24. Audio data: The audio input subsystem has a user-definable buffer size. This buffer is filled with raw PCM audio data from the input device. When the buffer nears capacity, an event fires. This event updates the VU meters, and then writes the buffer out to disk, converting the audio data to the selected format (i.e. MP3) in the process. Should this buffer be insufficient for the speed of the PC being used, it can be increased in size, however the VU meters will become sluggish as a result.

Communications
1. All communications with the tuner/receiver are done using an event-driven model. Commands are issued to the tuner/receiver as required. When responses are received from the tuner/receiver, the responses are decoded, and action is taken based upon their contents. An output buffer of commands is used, so that several commands can be streamed to the tuner/receiver at once, and when and as the responses are received, the response manager will deal with them appropriately.
2. When data is received from the tuner/receiver (at 9600 bps), it is stored in a large static buffer. The buffer is analyzed to determine whether or not it contains a complete response. If it does not, a timer is set for 10 ms, and the communications routine is exited. When the timer fires 10 ms later, the communications routine retrieves more data. This cycle continues until a complete response is received. If data is received before the 10 ms timer has fired, the communications routine disables the timer and processes the new data. Normally this cycle is not required, but if large responses occur across buffer boundaries, it may be required once.
3. The response manager analyzes the response from the tuner/receiver. Several commands can be processed:
   a. Power on—the tuner/receiver has powered on. It supplies the radio ID when this happens. The radio ID is recorded, and a “power on event” flag is set.
   b. Power off—the tuner/receiver has powered off. A “power off event” flag is set.
   c. Channel Set OK—the tuner/receiver has tuned to the requested channel. The current channel number is set to the tuned channel, and a “channel set event” flag is set.
d. Mute On/Off—the mute status is determined from the response (on/off) and a “mute event” flag is set.
   e. Channel Information—the tuner/receiver has returned requested channel information, including channel number, name, genre, artist name and song name. This information is handed to the channel information routine.
   f. Radio ID—the tuner/receiver has received the radio's ID. The radio ID is recorded, and a “radio ID event” flag is set.
   g. Signal Level—the tuner/receiver has received the current satellite and terrestrial signal levels. Calculations are made to convert the levels to percentages, and the data is handed to a signal level routine that updates the values on screen.
   h. XM Direct Strobe—this is the strobe information continually sent by the XM Direct tuner/receiver after power is applied to it. The response manager instantly sends a “terminate strobe” command to the XM Direct upon receiving this information, which allows the XM Direct to then operate in PCR mode.
   i. Power Off, Command Rejected—this is an error message. When received, the “power off event” flag is set.
4. After the command is processed, the routine loops back to the beginning to process any other waiting commands that may still be contained within the receive buffer.
5. The output buffer of commands sent to the tuner/receiver can contain up to 10 commands. The buffer is a FIFO buffer, and the appropriate command is flagged as complete by the routine that issued the command when the correct response has been received. All output commands are blocked until the top of the list command has had a response. If no response is received within 5 seconds, the command is deemed ignored, removed, and the next command in the buffer is sent. Certain commands have a “force” flag set to them, which indicates the command bypasses the output buffer and is sent directly to the radio. An instance is the “power off” command sent when The software is terminated, when outstanding commands are no longer pertinent. Certain internal processes can also clear the output buffer.

Channel Information Routine
1. This routine is called by the communication routine whenever channel information has been received from the tuner/receiver. It has two modes: Enumerating mode and non-enumerating mode.
2. In enumerating mode, The software has just started up, and is retrieving information for all channels. It accepts the channel information, and if it matches what it had expected to receive, it issues a request for the next channel from the tuner/receiver. If it does not match what it expected, it re-issues the request for the current channel. If the channel does not currently exist in the list, it is added. When it reaches the end of the list, as defined by a flag from the tuner/receiver, it starts over at 1 again. Once it has reached the end of the list the second time, it declares enumeration to be complete, turns off the enumeration flag, begins the recording phase, and enters normal operation.
   In non-enumerating mode, or regular operation mode, the channel information is received and the main channel listing is updated. If the channel does not currently exist in the list, it is added. The software Now buttons are updated if required. If the channel received is the currently tuned channel, then the main screen is updated.

Although alternate embodiments of the invention have been described with a degree of particularity, it is the intent that the invention includes all modifications and alterations from the disclosed design falling within the spirit or scope of the appended claims.

What is claimed:

1. A process for recording audio data comprising
establishing communications between a recording device and a transceiver;
commanding the transceiver to tune to a specified or current channel, as determined from the last time communications between the recording device and the transceiver was established;
displaying a user interface screen and if available loading a cache of available radio channel numbers and names on the user interface screen;
during a start up interval periodically querying the transceiver for a name, number, genre and currently playing artist and song for every channel available radio channel;
subsequent to said start up interval recording the current program to a memory store in a specified file format;
querying the transceiver for channel, artist and song information by alternating between a currently playing channel, and other available channels to update a listing of channels while monitoring changes to the currently playing channel at more frequent intervals.

2. The method of claim 1 additionally comprising:
monitoring user input channel changes or a given performance or song ending on a selected channel as inidicated by the artist/song information changing and stopping the recording to a first capture file, and beginning to record a second capture file.

3. The method of claim 2 comprising alternating between storing the two capture files so that in a “record” mode subsequent to recording to the second capture file, the first capture file is renamed.

4. The method of claim 2 comprising deleteing the first file subsequent to beginning capture of the second file.

5. The method of claim 1 wherein the file format is defined by displaying to the user a configuration screen from which the user chooses a file format.

6. The method of claim 1 comprising timing elapsed time and initiating an update process of the recording upon occurance of a specified amount of elapsed time.
